(19) United States
(12) Patent Application Publication
(10) Pub. No.: US 2025/0165307 A1
(43) Pub. Date: May 22, 2025

(54) RESOURCE EXHAUSTION RECOVERY IN ORDERED NETWORKS

(71) Applicant: Hewlett Packard Enterprise Development LP, Spring, TX (US)

(72) Inventors: Keith D. Underwood, Fort Collins, CO (US); Steven Welch, Mansfield, TX (US)

(21) Appl. No.: 18/644,452

(22) Filed: Apr. 24, 2024

Related U.S. Application Data
(60) Provisional application No. 63/601,032, filed on Nov. 20, 2023.

(51) Int. Cl. G06F 9/50

(52) U.S. Cl. CPC G06F 9/5083

(57) ABSTRACT

Techniques for managing resource exhaustion in message-passing communication within a computing system are disclosed. A method, executed by a destination compute node, involves provisioning additional resources for a processing table entry in a message processing table when the entry's resources are exhausted. The method includes incrementing a generation number for the processing table entry from a previous value to a current value. A first message from a source compute node that includes the previous value of the generation number is rejected, while the same message is accepted when it includes the current value of the generation number, thereby facilitating ordered message-passing and recovery from resource exhaustion.

### CROSS-REFERENCE TO RELATED APPLICATIONS

This application claims the benefit of U.S. Provisional Application No. 63/601,032, filed on Nov. 20, 2023, which application is hereby incorporated herein by reference.

### BACKGROUND

Message-passing communication allows processes executing on compute nodes to exchange messages with one another in a synchronized fashion. For example, processes may exchange messages via a network, such as a high-speed interconnect or other suitable type of network. Message-passing may be used to share data or for other suitable purposes. Messages may be exchanged using a message-passing protocol, such as Message Passing Interface (MPI), Open Symmetric Hierarchical Memory (OpenSHMEM), NVIDIA Collective Communications Library (NCCL), or the like.

### BRIEF DESCRIPTION OF THE DRAWINGS

Aspects of the present disclosure are best understood from the following detailed description when read with the accompanying figures.

FIG. 1 is a block diagram of a computing system, according to some implementations.

FIG. 2 is a block diagram of a computing system, according to some implementations.

FIG. 3 is a block diagram of a message processing table, according to some implementations.

FIG. 4 is a sequence diagram of a resource exhaustion recovery method, according to some implementations.

FIG. 5 is a flow diagram of a destination recovery method, according to some implementations.

FIG. 6 is a flow diagram of a source recovery method, according to some implementations.

FIG. 7 is a flow diagram of a destination recovery method, according to some implementations.

FIG. 8 is a block diagram of a destination compute node, according to some implementations.

FIG. 9 is a flow diagram of a source recovery method, according to some implementations.

FIG. 10 is a block diagram of a source compute node, according to some implementations.

FIG. 11 is a sequence diagram of a resource exhaustion recovery method, according to some implementations.

Corresponding numerals and symbols in the different figures generally refer to corresponding parts unless otherwise indicated. The figures are drawn to clearly illustrate the relevant aspects of the disclosure and are not necessarily drawn to scale.

### DETAILED DESCRIPTION

The following disclosure provides many different examples for implementing different features. Specific examples of components and arrangements are described below to simplify the present disclosure. These are, of course, merely examples and are not intended to be limiting.

Message-passing communication may be used by compute nodes (including source compute nodes and destination compute nodes) in parallel computing. For example, in a high performance computing (HPC) system, a source process executing on a source compute node may send a message to a destination process executing on a destination compute node via a network. HPC environments may utilize a client-server architecture. Some message-passing protocols call for strict point-to-point message ordering.

Resource exhaustion is a challenge in message-passing communication. Resource exhaustion occurs when a compute node runs out of a resource need to handle messages. Unexpected messages are one cause of resource exhaustion. Unexpected messages occur when a source process sends a message that reaches a destination compute node before a destination process has prepared to receive the message. A destination compute node may buffer the headers and/or payloads of unexpected messages. However, the buffering of unexpected messages is subject to resource constraints that can lead to resource exhaustion. Resource exhaustion may occur in a compute node's memory and/or a compute node's network interface card (NIC), and presents a challenge for ordered message-passing.

The present disclosure describes resource exhaustion recovery techniques which may be utilized in ordered message-passing. A destination compute node maintains a message processing table that maps and manages resources for message-passing. The message processing table includes multiple message processing table entries; each processing table entry (PTE) corresponds to resources (such as memory buffers) and rules for processing messages that are sent to the destination compute node. A message includes addressing information that is used by the destination compute node to select an appropriate PTE, which dictates how the message is processed by the destination compute node. For example, a PTE may dictate where messages sent to that PTE should be buffered and to what destination process(es) the messages should be delivered.

Each PTE includes a generation number. When the resources of a PTE are exhausted, the destination compute node disables the exhausted PTE so that no messages may be routed to that PTE. While the PTE is disabled, the destination compute node provisions additional resources for the PTE. The generation number of the PTE is incremented from a previous value to a current value. The PTE is then reenabled so that messages may again be routed to that PTE.

An incoming message is addressed to a PTE and includes a value for the generation number of that PTE. The destination compute node accepts messages having the current value of the generation number, but rejects messages having mismatched (e.g., previous) values of the generation number. When the source compute node receives a response indicating rejection of messages due to generational mismatch, it resends the messages (in the appropriate order) with the current value of the generation number. In this way, messages that were in flight to the destination compute node (during provisioning of additional resources for the PTE) may be rejected and message order may be maintained during resource exhaustion recovery.

A source compute node may handle rejection of a message in multiple manners. A semantic response to the source compute node may indicate resource exhaustion of a PTE. The source compute node may respond by waiting some time for the destination compute node to provision additional resources for the PTE and creating a new value for the generation number by incrementing the previous value. Additionally or alternatively, a semantic response to the source compute node indicates generational mismatch with the PTE and includes the new value for the generation number. In either case, the source compute node may resend the message with the new value for the generation number.

Utilizing a message processing table with a generation number for a PTE advantageously allows a destination compute node to asynchronously provision additional resources for and then reenable a PTE. Out-of-order messages received after the provisioning of the additional resources may be rejected by the destination compute node, so that the messages are resent in their initial order by the source compute node. The PTE may be reenabled more quickly than other recovery techniques (such as using out-of-band communication to collectively synchronize the compute nodes), which may improve the performance of message-passing.

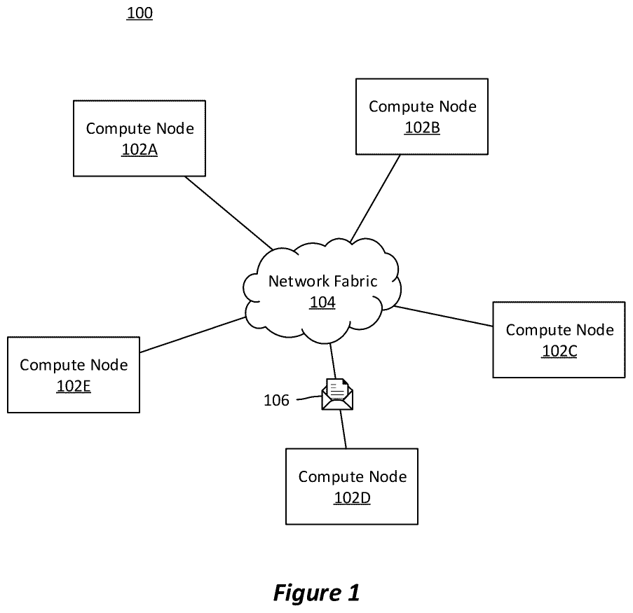

FIG. 1 is a block diagram of a computing system 100, according to some implementations. The computing system 100 may be part of a computing environment, such as an HPC environment, capable of parallel execution of computing processes, such as processes of a distributed application. The computing system 100 may utilize a client-server architecture. The computing system 100 includes multiple compute nodes 102 (including compute nodes 102A, 102B, 102C, 102D, 102E) and a network fabric 104.

The compute nodes 102 work together to perform HPC computations. For example, a task may be divided into smaller segments that may be parallelized across the compute nodes 102. Process(es) may be executed on the compute nodes 102 to perform the HPC computations. The compute nodes 102 may be implemented using any suitable combination of hardware, firmware, and software. For example, each compute node 102 may be a standalone unit equipped with a processor, memory, and the like (subsequently described).

The network fabric 104 facilitates the coordination and synchronization of the compute nodes 102 when performing HPC computations. The network fabric 104 may include routers, switches, links, and the like. The components of the network fabric 104 work together to provide a high-bandwidth interconnection between the compute nodes 102. The design of the network fabric 104 may prioritize low latency and high throughput among the connected components. For example, the network fabric 104 may be based on a technology such as InfiniBand, Ultra Ethernet Transport, or the like.

The compute nodes 102 may communicate with one another by exchanging messages 106 via the network fabric 104. A message 106 may include a payload (e.g., data intended for consumption by an entity receiving the message 106) and any number of headers and/or trailers. The headers and/or trailers include fields of information that allow the components of the network fabric 104 to propagate a message 106 towards a destination (e.g., another device, an application receiver, etc.). The messages 106 may be exchanged via a suitable message-passing protocol, such as Message Passing Interface (MPI), Open Symmetric Hierarchical Memory (OpenSHMEM), NVIDIA Collective Communications Library (NCCL), or the like, which may use any suitable underlying network programming interface, such as Portals, libfabric, Remote Direct Memory Access (RDMA), or the like.

An application may be executed using one or more compute nodes 102, which execute processing tasks, such as portions of a distributed application for execution in a potentially parallel manner. For example, these processing tasks may be assigned to the compute nodes 102 (e.g., by a scheduler/orchestrator) as execution flows that involve the compute nodes 102 executing computer code, potentially in portions. To that end, the compute nodes 102 may execute one or more processes of the application, working together to execute the application.

In association with executing the one or more processes, such as during runtime, the compute nodes 102 may communicate by sending messages 106 to one other. The messages may include control messages and/or data messages. The messages 106 also may be referred to as inter-process communications, as the messages 106 may be sent from one process to another process. For example, some execution flows may involve multiple compute nodes 102 and potentially an exchange of messages 106 by the compute nodes 102. In certain implementations, any of the compute nodes 102 can be a sender of messages 106 and/or a receiver of messages 106.

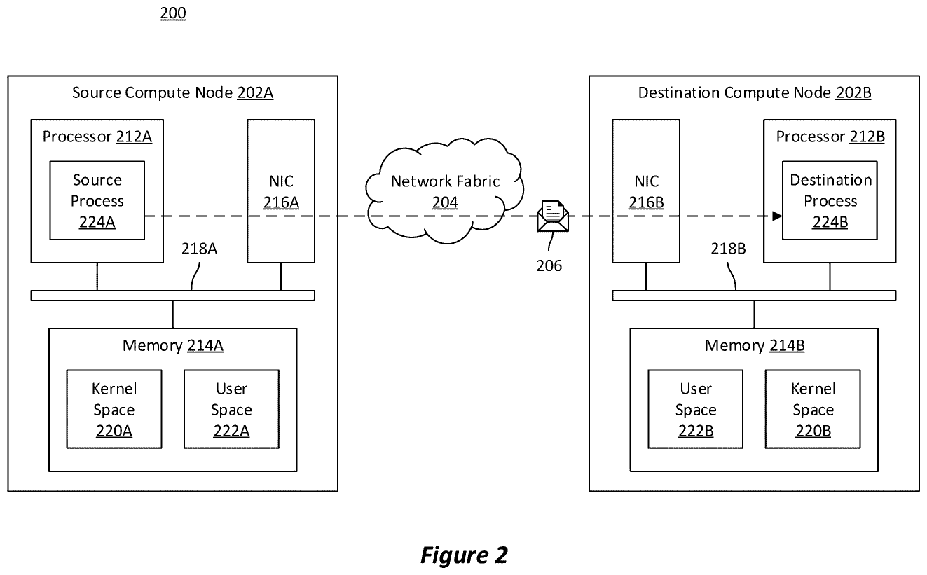

FIG. 2 is a block diagram of a computing system 200, according to some implementations. The computing system 200 is an example implementation of the computing system 100 previously described for FIG. 1. Additional details of the computing system 200, including details of compute nodes 202 (including a source compute node 202A and a destination compute node 202B), are shown. Furthermore, additional details of exchanging messages 206 between the compute nodes 202 via a network fabric 204 are illustrated.

The source compute node 202A includes various hardware components. For example, the source compute node 202A may include a processor 212A, a memory 214A, and a NIC 216A. The hardware components may be interconnected through a number of busses and/or network connections. In one example, the processor 212A, the memory 214A, and the NIC 216A may be communicatively coupled via a bus 218A.

The processor 212A retrieves executable code from the memory 214A and executes the executable code. The executable code may, when executed by the processor 212A, cause the processor 212A to implement any functionality described herein. The processor 212A may be a microprocessor, an application-specific integrated circuit, a microcontroller, a general purpose graphics processing unit (GPGPU), or the like.

The memory 214A may include various types of memory, including volatile and nonvolatile memory. For example, the memory 214A may include Random-Access Memory (RAM), Read-Only Memory (ROM), a Hard Disk Drive (HDD), and/or the like. Different types of memory may be used for different data storage needs. For example, the processor 212A may boot from ROM, maintain nonvolatile storage in an HDD, execute program code stored in RAM, and store data under processing in RAM. The memory 214A may include a non-transitory computer readable medium that stores instructions for execution by the processor 212A. One or more modules within the source compute node 202A may be partially or wholly embodied as software and/or hardware for performing any functionality described herein.

The memory 214A may include a kernel space 220A and a user space 222A. The kernel space 220A may be a reserved area of memory (e.g., the memory 214A) for running an operating system kernel, kernel extensions, device drivers, and the like. The user space 222A may be an area of memory (e.g., the memory 214A) for running code outside the operating system kernel and generally includes data for running software applications.

The NIC 216A may be used to connect to the network fabric 204 and communicate with other devices over the network fabric 204. The NIC 216A facilitates the transmission and reception of data packets between the source compute node 202A and other compute nodes (via the network fabric 204), and may adhere to one or more networking standards such as Ethernet, InfiniBand, and the like.

The destination compute node 202B includes various hardware components. The destination compute node 202B may (or may not) include similar components as those described for the source compute node 202A. For example, the destination compute node 202B may include a processor 212B, a memory 214B, and a NIC 216B, each of which may be communicatively coupled via a bus 218B. Likewise, the memory 214B may include a kernel space 220B and a user space 222B.

In the illustrated example, the source compute node 202A and the destination compute node 202B execute respective processes of a distributed application. Specifically, the processor 212A of the source compute node 202A is executing a source process 224A, and the processor 212B of the destination compute node 202B is executing a destination process 224B. Although the source process 224A is shown within the processor 212A to reflect that the processor 212A is executing the source process 224A, in certain implementations data for the source process 224A may reside in the memory 214A. For example, data for the source process 224A may reside in the user space 222A. Similarly, data for the destination process 224B may reside in the user space 222B.

The source process 224A of the source compute node 202A may send a message 206 to the destination process 224B of the destination compute node 202B. A compute node may be considered a “source compute node” or a “destination compute node” from the perspective of a message 206. Likewise, a process may be considered a “source process” or a “destination process” from the perspective of a message 206. In other words, for the message 206 of this example, the source compute node 202A is the sending compute node, the source process 224A is the sending process, the destination compute node 202B is the receiving compute node, and the destination process 224B is the receiving process. The source process 224A may send the message 206 via the NIC 216A of the source compute node 202A, and the destination process 224B may receive the message 206 via the NIC 216B of the destination compute node 202B. For example, when data for the source process 224A resides in the user space 222A and data for the destination process 224B resides in the user space 222B, the message 206 may be copied from the user space 222A to the user space 222B.

During healthy message-passing, a destination process 224B makes a call to receive a message 206 before a source process 224A makes a call to send the message 206. Thus, the destination process 224B is expecting the message 206, and the message 206 may be placed in the part of the user space 222B for the destination process 224B. However, in some circumstances, the source process 224A may make a call to send the message 206 before the destination process 224B makes a call to receive the message 206. Thus, the destination process 224B is not expecting the message 206, and the unexpected message 206 may be buffered. The message 206 may be buffered until the destination process 224B makes a call to receive the message 206, at which time the message 206 may be placed in the part of the user space 222B for the destination process 224B. Unexpected messages 206 may be buffered in another part of the user space 222B, the kernel space 220B, the NIC 216B, or the like. Particular resources (e.g., memory buffers) of the destination compute node 202B may be provisioned for buffering unexpected messages 206. When a large number of unexpected messages 206 are buffered, the resources allocated for buffering the messages 206 may be exhausted. Buffering of the messages 206 at the destination compute node 202B may be controlled by a message processing table stored at the destination compute node 202B.

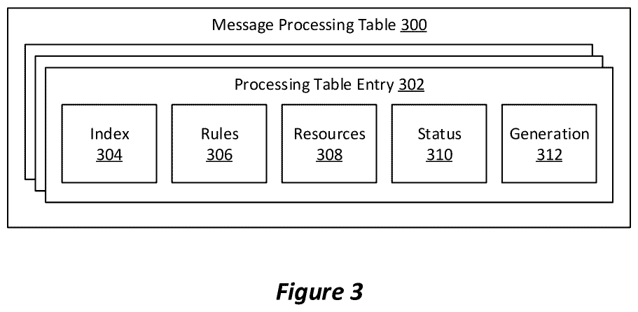

FIG. 3 is a block diagram of a message processing table 300, according to some implementations. FIG. 3 will be described in conjunction with FIG. 2. The message processing table 300 may be stored at the destination compute node 202B. Routing and buffering of the messages 206 at the destination compute node 202B may be controlled by the message processing table 300. The message processing table 300 maps and manages resources for message-passing, and is used to direct the flow of messages within the destination compute node 202B. The message processing table 300 may be stored in a part of the user space 222B, the kernel space 220B, the NIC 216B, or the like.

The message processing table 300 is a table for controlling the flow and processing of messages. The message processing table 300 includes multiple PTEs 302, which may be indexed within the message processing table 300. The implementation of the message processing table 300 depends on the message-passing protocol used for exchanging the messages 206. For example, when MPI and Portals are used for exchanging the messages 206, each PTE 302 may be a Portal Table Entry.

A PTE 302 is a message control entry that includes resources (such as memory buffers) and rules for processing messages 206 that are sent to the destination compute node 202B. Each PTE 302 includes one or more fields that may be used to control routing and buffering of a message 206. In this implementation, the fields of a PTE 302 include an index 304, rules 306, resources 308, a status 310, and a generation 312. Each of the fields may be stored in a column of the message processing table 300, or may include one or more bits stored in one or more shared columns of the table.

The index 304 is an identifier for a PTE 302. A message 206 includes addressing information that is used by the destination compute node 202B to select an appropriate PTE 302. The addressing information may be index-based. For example, a message 206 may include a header that includes an index of a PTE 302. When a message 206 is received by the destination compute node 202B, the corresponding PTE 302 is selected from the message processing table 300 using the index in the message 206. The selected PTE 302 may then be used by the destination compute node 202B to process the message 206. As used herein, a message being “sent to” a PTE 302 means the addressing information of the message corresponds to the PTE 302.

The rules 306 are message processing rules for a PTE 302. The message processing rules dictate how a message 206 should be processed by the destination compute node 202B. For example, the message processing rules of a PTE 302 may indicate that a message 206 sent to the PTE 302 should be delivered to the destination process 224B (by placing the message 206 in the part of the user space 222B for the destination process 224B).

The resources 308 include any resources needed to process, service, or complete messages sent to a PTE 302. The resources may include, e.g., pointers to memory buffers. The memory buffers may be used to store unexpected messages, tracking entries for unexpected messages, completion queue entries, and the like. The resources may be used for buffering unexpected messages 206. Upon receiving an unexpected message 206 sent to a PTE 302, the destination compute node 202B may buffer the message with the resources 308 indicated by the PTE 302 until the message 206 is called for by the destination process 224B, at which point the message 206 may be processed using the rules 306 of the PTE 302.

The status 310 indicates whether a PTE 302 is enabled or disabled. When a PTE 302 is enabled (by setting its status 310 to enabled), the destination compute node 202B accepts and processes messages 206 sent to the PTE 302. When a PTE 302 is disabled (by setting its status 310 to disabled), the destination compute node 202B rejects messages 206 sent to the PTE 302. For example, a semantic response may be sent back to the source compute node 202A, indicating a message 206 was rejected. As subsequently described in greater detail, when the resources of a PTE 302 are exhausted, the PTE 302 may be disabled while additional resources are provisioned for it. The PTE 302 may not be used to process messages 206 while it is disabled, such that messages 206 the PTE 302 receives when disabled are rejected. Once the additional resources have been provisioned, a PTE 302 may be reenabled so that it can once again process messages 206.

The generation 312 indicates the current generation number of a PTE 302 at runtime. The generation number of a PTE 302 is tracked by both a source compute node 202A and a destination compute node 202B. A message 206 sent to a PTE 302 includes information that is used by the destination compute node 202B for determining to which generation of the PTE 302 the message 206 corresponds. For example, a message 206 from a source compute node 202A may include a header that includes a field for a generation number of a PTE 302. As subsequently described in greater detail, when additional resources are provisioned for a PTE 302 after a resource exhaustion has occurred, the generation 312 of the PTE 302 is incremented at the destination compute node 202B. The new generation number will be indicated (implicitly or explicitly) to the source compute node 202A. This allows other compute nodes in the message-passing protocol to know that the resource entry 302 has been updated and is available for processing new messages.

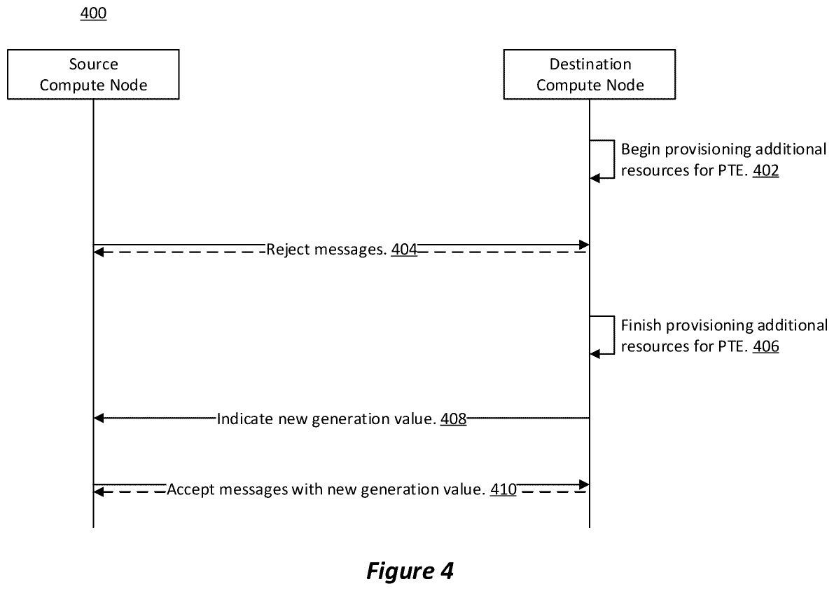

FIG. 4 is a sequence diagram of a resource exhaustion recovery method 400, according to some implementations. FIG. 4 will be described in conjunction with FIG. 3. The resource exhaustion recovery method 400 may be performed in a computing system when a PTE 302 at a destination compute node is exhausted of resources. For example, the resource exhaustion recovery method 400 may be performed when the resources 308 of a PTE 302 are exhausted during ordered message-passing, such as on account of buffering unexpected messages sent to the PTE 302.

In step 402, the destination compute node begins provisioning additional resources for the PTE 302. Provisioning additional resources for the PTE 302 may include appending new resources to the existing resources 308 of the PTE 302. For example, the resources 308 may be memory buffers, and provisioning additional resources the PTE 302 may include increasing the size of existing memory buffers or allocating additional memory buffers that are added to the resources 308 of the PTE 302. The PTE 302 is disabled, so that messages may not be sent to the PTE 302 (e.g., by the source compute node) during the provisioning of the additional resources. For example, the status 310 of the PTE 302 may be set to a value indicating it is disabled.

In step 404, messages sent to the PTE 302 during the provisioning of the additional resources are rejected by the destination compute node. The rejected messages are not buffered by the destination compute node. A notification of the message rejection may be sent to the source compute node. For example, a semantic response may be sent to the source compute node, indicating the PTE 302 is disabled. More generally, such a semantic response may indicate resource exhaustion of the PTE 302.

In step 406, the destination compute node finishes provisioning the additional resources for the PTE 302. The provisioning may be completed once the new resources have been appended to the existing resources 308 of the PTE 302. The generation 312 of the PTE 302 is incremented, so that a generational mismatch will occur with out-of-order messages that were in flight to the PTE 302 during the provisioning of the additional resources. For example, the value in the generation 312 of the PTE 302 may be incremented (e.g., by one) from a previous value to a current value (or more generally, from a first value to a second value). The PTE 302 is then enabled, so that messages may once again be sent to the PTE 302 (e.g., by the source compute node). For example, the status 310 of the PTE 302 may be set to a value indicating it is enabled.

In step 408, the destination compute node indicates the (new) current value of the generation 312 of the PTE 302 to the source compute node. The current value of the generation 312 may be indicated explicitly or implicitly. As a result, the source compute node may be able track the value for the generation number of the PTE 302.

In some implementations, the current value of the generation number of the PTE 302 is explicitly indicated in a semantic response to the source compute node. Such a semantic response may be sent to the source compute node responsive to detecting a generational mismatch with the source compute node. For example, the source compute node may attempt to send a message to the PTE 302 with an old (previous) value of the generation number. A semantic response may be sent to source compute node, rejecting the message, which response includes the current value of the generation number. As another example, such a semantic response may be sent if the source compute node attempts to send a message during the provisioning of the additional resources (in step 404). The semantic response may include the future value of the generation number.

In some implementations, the current value of the generation number of the PTE 302 is implicitly indicated in a semantic response to the source compute node. For example, if the source compute node attempts to send a message during the provisioning of the additional resources (in step 404), the rejection of the message may cause the source compute node to automatically increment its local value of the generation number. When a message is rejected on account of resource exhaustion, a source compute node may be able to assume that the generation number will be increased.

In step 410, the source compute node sends messages to the PTE 302 with the current value of the generation number, which messages are accepted by the destination compute node. The source compute node may send the messages to the destination compute node, and the destination compute node may respond with an acknowledgment. For example, the message that are sent may be the messages that were rejected in step 404; those message may be resent in the same order that they were initially sent. The accepted messages are buffered and/or processed according to the PTE 302. On the other hand, messages sent to the PTE 302 with the previous value of the generation number are rejected by the destination compute node. A semantic response may be sent to the source compute node, indicating a generational mismatch and (optionally) the current value of the generation number.

The value of the generation number may be included with a message in multiple manners. For example, a subset of the bits in a header/payload of the message may be interpreted as a generation number. In some implementations, a message includes an index of a desired PTE 302. The index itself may include the generation number. For example, a subfield of the index may include bits that can be interpreted as a generation number. In some implementations, a message includes a field for the generation number, which is different than the index of the desired PTE 302. Another field of the message may include one or more bits that are interpreted as a generation number. The field may have an implementation-specific number of bits in its length. The number of bits interpreted as an index may vary based on the PTE 302.

Utilizing a generation number for a PTE 302 advantageously allows a destination compute node to asynchronously provision additional resources for and reenable the PTE 302. The need to collectively synchronize the compute nodes (to preserve message ordering) before reenabling the PTE 302 may be obviated. Avoiding collective synchronization of the compute nodes may be particularly advantageous in some types of HPC environments, such as those with a client-server architecture.

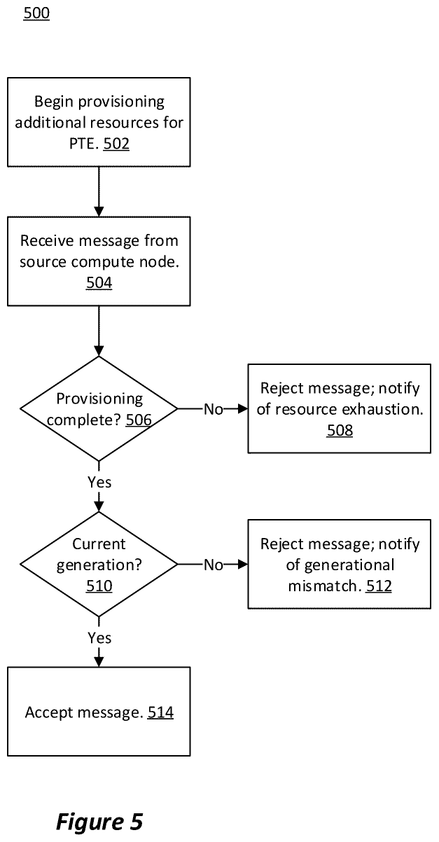

FIG. 5 is a flow diagram of a destination recovery method 500, according to some implementations. The destination recovery method 500 may be performed by a destination compute node of a computing system (e.g., the destination compute node 202B of FIG. 2) when exchanging messages with a source compute node of the computing system (e.g., the source compute node 202A of FIG. 2), specifically, when a PTE at the destination compute node has its resources exhausted.

The destination compute node may perform a step 502 of beginning the provisioning of additional resources for the PTE. As previously noted, this may include disabling the PTE and appending new resources to the existing resources of the PTE. The additional resources may be provisioned in response to exhaustion of the resources of the PTE.

The destination compute node may perform a step 504 of receiving a message from the source compute node. The message may be sent to the PTE over a network fabric. The message may include a payload, an index of the PTE, and a value for a generation number of the PTE. The PTE for the message may be identified based on the index in the message.

The destination compute node may perform a step 506 of determining whether the provisioning of additional resources (initiated in step 502) is complete. For example, the destination compute node may check whether the PTE is enabled/disabled. The PTE being enabled may mean the provisioning is complete, while the PTE being disabled may mean the provisioning is incomplete.

Responsive to the provisioning being incomplete, the destination compute node may perform a step 508 of rejecting the message from the source compute node. Rejecting the message may include sending a semantic response to the source compute node. The semantic response may notify the source compute node that the resources of the target PTE are exhausted.

Responsive to the provisioning being complete, the destination compute node may perform a step 510 of determining whether the message was sent with the current value of the generation number of the target PTE. The generation number of the message may be included in a header of the message, as previously described. That value may be compared to the generation of the target PTE. The generation values matching means the message was sent with the current value of the generation number. The generation values mismatching means the message was sent without the current value of the generation number (e.g., was sent with a previous value of the generation number).

Responsive to the message being sent without the current value of the generation number, the destination compute node may perform a step 512 of rejecting the message from the source compute node. Rejecting the message may include sending a semantic response to the source compute node. The semantic response may notify the source compute node that the message generation is mismatched with the target PTE. Optionally, the semantic response may include the current value of the generation number of the target PTE.

Responsive to the message being sent with the current value of the generation number, the destination compute node may perform a step 514 of accepting the message from the source compute node. An acknowledgment may be sent to the source compute node. The message may be buffered and/or processed according to the rules of the target PTE.

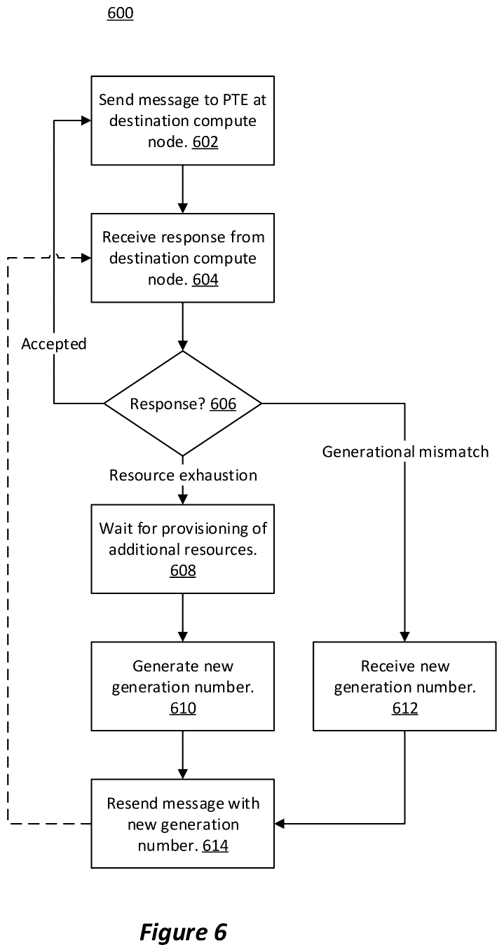

FIG. 6 is a flow diagram of a source recovery method 600, according to some implementations. The source recovery method 600 may be performed by a source compute node of a computing system (e.g., the source compute node 202A of FIG. 2) when exchanging messages with a destination compute node of the computing system (e.g., the destination compute node 202B of FIG. 2), specifically, when a PTE at the destination compute node has its resources exhausted.

The source compute node may perform a step 602 of sending a message to the PTE at the destination compute node. The message may include a payload, an index of the PTE, and a value for a generation number of the PTE. The value for a generation number may be tracked locally at the source compute node.

The source compute node may perform a step 604 of receiving a semantic response from the destination compute node. The semantic response may be an acknowledgment (indicating the message was accepted by the PTE) or a rejection. The rejection may indicate the previously sent message was not buffered and/or processed by the destination compute node. Responsive to the semantic response (received in step 604) indicating the message was accepted by the PTE, the source compute node may send another message by proceeding back to step 602.

The source compute node may perform a step 606 of determining the type of the semantic response (received in step 604). The semantic response may indicate the message was accepted by the PTE, may indicate resource exhaustion of the PTE, or may indicate generational mismatch of the message with the PTE.

Responsive to the semantic response (received in step 604) indicating resource exhaustion of the PTE, the source compute node may perform a step 608 of waiting for additional resources to be provisioned for the PTE at the destination compute node. For example, the source compute node may wait a predetermined duration (or amount of time) before proceeding. Waiting gives the destination compute node a chance to provision additional resources for the PTE.

The source compute node may perform a step 610 of generating a new value for the generation number of the PTE. The new value may be generated by incrementing the previous value, e.g., by adding one to the previous value.

The new value for the generation number of the PTE may be obtained in another manner. Specifically, and responsive to the semantic response (received in step 604) indicating generational mismatch of the message with the PTE, the source compute node may perform a step 612 of receiving the new value for the generation number of the PTE from the destination compute node. The new value for the generation number may be included with the semantic response. When the new value for the generation number is directly provided by the destination compute node, then no waiting may be performed (as was performed in step 608). The source compute node may immediately attempt to resend the message, as generational mismatch would not have occurred unless the provisioning of additional resources at for the PTE (at the destination compute node) were complete. In either case, the new value for the generation number is obtained by the source compute node.

The source compute node may perform a step 614 of resending the message with the new value for the generation number. The new value for the generation number may have been the value generated in step 610 or the value received in step 612.

Multiple messages may be rejected in succession, such as on account of the messages being in flight simultaneously or on account of multiple resource exhaustions occurring in rapid succession. For example, an initial message may be rejected, and then subsequent messages after that initial message may also be rejected before the initial message is successfully resent. In this case, the source compute node may also perform appropriate operations (not separately illustrated in FIG. 6) to preserve message ordering. As a result, the messages may be resent in the same order that they were initially sent.

In some implementations, an initial message (e.g., the first in the original message ordering) may be resent until it is accepted by the PTE. Specifically, the initial message may be rejected in step 614, and each time the initial message is rejected the source compute node may (as indicated by the dashed line) go back to step 604. When the initial message is rejected in step 614, another new value for the generation number may be obtained (as previously described for steps 608-612) and the initial message may again be resent with the value for the generation number (as previously described for step 614). This may occur multiple times, such as if an incorrect generation number is selected in step 610 during a first resend and then the correct generation number is obtained in step 612 during a second resend. Meanwhile, subsequent messages (in the original message ordering) after the initial message may be queued in a retry list when they are rejected by the PTE. That is, resending the initial message (in step 614) may include directly resending the initial message without queueing the initial message, while resending the subsequent messages (in step 614) may include indirectly resending the subsequent messages by queueing the subsequent messages.

Once the initial message is successfully transmitted, the transmission of the subsequent messages (queued in the retry list) may be performed at full rate. For example, when the response to the initial message indicates acceptance (in step 606), the subsequent messages queued in the retry list may be sent (in their order within the list) before step 602 is repeated. Waiting until the initial message is successfully transmitted before resuming transmission at full rate may help avoid a race condition where the destination compute node may not have provisioned additional resources before the initial message arrives, but would do so before the subsequent messages arrive. Additionally, the original message ordering may be preserved.

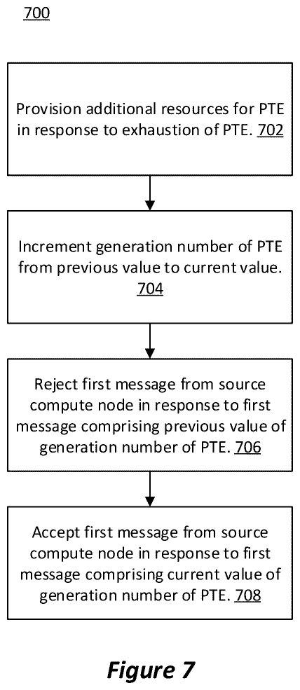

FIG. 7 is a flow diagram of a destination recovery method 700, according to some implementations. The destination recovery method 500 may be performed by a destination compute node of a computing system (e.g., the destination compute node 202B of FIG. 2) when exchanging messages with a source compute node of the computing system (e.g., the source compute node 202A of FIG. 2).

The destination compute node may perform a step 702 of provisioning additional resources for a PTE of a message processing table in response to resource exhaustion of the PTE. The destination compute node may perform a step of disabling the PTE before provisioning the additional resources for the PTE. The destination compute node may perform a step of enabling the PTE after provisioning the additional resources for the PTE.

The destination compute node may perform a step 704 of incrementing a generation number of the PTE from a previous value to a current value. For example, the current value of the generation number may be produced by adding one to the previous value of the generation number.

The destination compute node may perform a step 706 of rejecting a first message from a source compute node in response to the first message comprising the previous value of the generation number of the PTE. The first message may comprise an index of the PTE, the index comprising the generation number. The first message may comprise a field for the index, and the field may comprise a subfield for the generation number. The first message may comprise an index of the PTE, the index being different than the generation number. The first message may comprise a first field for the index and a second field for the generation number. Rejecting the first message from the source compute node may comprise sending a semantic response to the source compute node, the semantic response comprising the current value of the generation number of the PTE.

The destination compute node may perform a step 708 of accepting the first message from the source compute node in response to the first message comprising the current value of the generation number of the PTE.

Optionally, the destination compute node may perform additional steps. The destination compute node may perform a step of rejecting a second message from the source compute node in response to the PTE being disabled. The destination compute node may perform a step of accepting the second message from the source compute node in response to the PTE being enabled. The step of rejecting the second message from the source compute node may comprise sending a semantic response to the source compute node, the semantic response lacking (or not including) the current value of the generation number of the PTE.

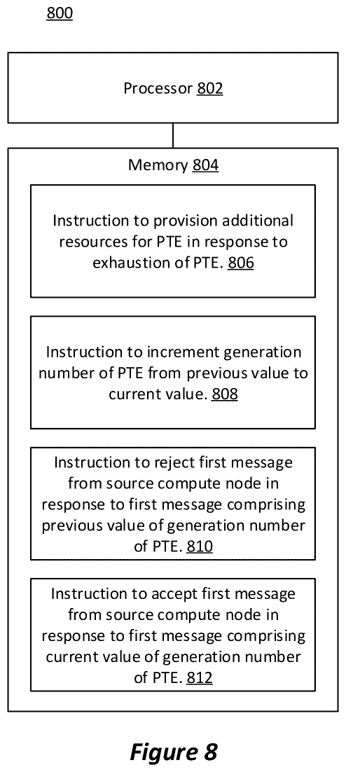

FIG. 8 is a block diagram of a destination compute node 800, according to some implementations. The destination compute node 800 may include a processor 802 and a memory 804. The memory 804 may be a non-transitory computer readable medium that stores programming for execution by the processor 802. In this implementation, one or more modules within the destination compute node 800 may be partially or wholly embodied as software for performing any functionality described herein. For example, the memory 804 may include instructions 806-812 for performing the destination recovery method 700 previously described for FIG. 7.

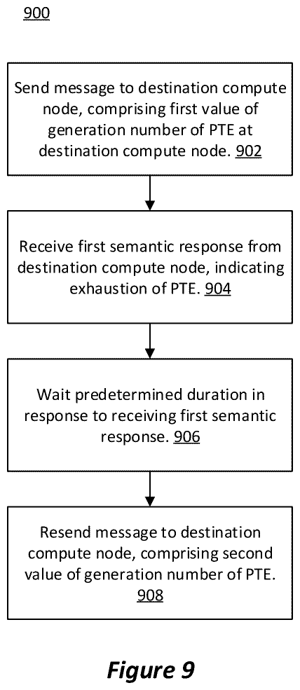

FIG. 9 is a flow diagram of a source recovery method 900, according to some implementations. The source recovery method 900 may be performed by a source compute node of a computing system (e.g., the source compute node 202A of FIG. 2) when exchanging messages with a destination compute node of the computing system (e.g., the destination compute node 202B of FIG. 2).

The source compute node may perform a step 902 of sending a message to a destination compute node, the message comprising a first value of a generation number of a PTE at the destination compute node. The PTE may be part of a message processing table at the destination compute node. The message may comprise a field for addressing information of the message, and the field may comprise a subfield for the generation number. The message may comprise a first field for addressing information of the message and a second field for the generation number.

The source compute node may perform a step 904 of receiving a first semantic response from the destination compute node, the first semantic response indicating resource exhaustion of the PTE. The first semantic response may (or may not) include a second value of the generation number of the PTE.

The source compute node may perform a step 906 of waiting a predetermined duration in response to receiving the first semantic response. The predetermined duration may be any suitable amount of time. For instance, it could be determined based on the expected time it takes for the destination compute node to provision additional resources for the PTE. It could also be dynamically adjusted based on network conditions, the load on the destination compute node, the severity of the resource exhaustion, or the like. The duration may provide enough time for the destination compute node to recover from resource exhaustion and prepare to receive a resent message, without prolonging a delay in message transmission.

The source compute node may perform a step 908 of resending the message to the destination compute node after the wait of the predetermined duration, the message comprising a second value of the generation number of the PTE, the second value different than the first value. For example, the second value may be greater than the first value.

Optionally, the source compute node may perform additional steps. The source compute node may perform a step of generating the second value of the generation number by incrementing the first value. The source compute node may perform a step of receiving a second semantic response from the destination compute node, the second semantic response indicating generational mismatch with the PTE. The source compute node may perform a step of resending the message to the destination compute node, the message comprising a third value of the generation number of the PTE, the third value different than the second value. The second semantic response may comprise the third value of the generation number. The message with the third value of the generation number may be resent to the destination compute node without waiting after receiving the second semantic response.

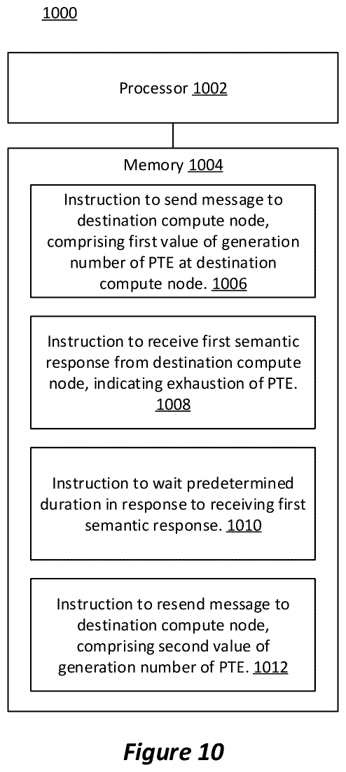

FIG. 10 is a block diagram of a source compute node 1000, according to some implementations. The source compute node 1000 may include a processor 1002 and a memory 1004. The memory 1004 may be a non-transitory computer readable medium that stores programming for execution by the processor 1002. In this implementation, one or more modules within the source compute node 1000 may be partially or wholly embodied as software for performing any functionality described herein. For example, the memory 1004 may include instructions 1006-1012 for performing the source recovery method 900 previously described for FIG. 9.

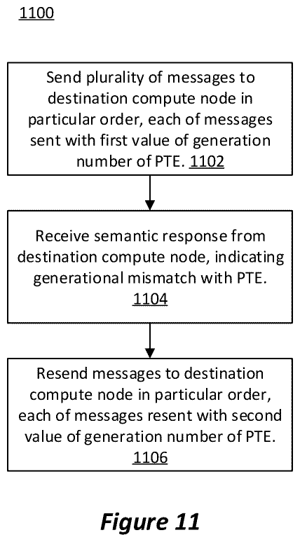

FIG. 11 is a sequence diagram of a resource exhaustion recovery method 1100, according to some implementations. The resource exhaustion recovery method 1100 may be performed in a computing system when a PTE at a destination compute node is exhausted of resources. The source/destination compute nodes (e.g., the source compute node 202A and the destination compute node 202B of FIG. 2) may be configured to perform the steps of the resource exhaustion recovery method 1100.

The destination compute node comprises a message processing table. The message processing table comprises a PTE. The PTE comprises a generation number. The PTE may further comprise an index and each of the messages may be sent with the index.

The source compute node may perform a step 1102 of sending a plurality of messages to the destination compute node in a particular order, each of the messages sent with a first value of the generation number of the PTE. The source compute node may perform a step 1104 of receiving a semantic response from the destination compute node, the semantic response indicating generational mismatch with the PTE. The source compute node may perform a step 1106 of resending the messages to the destination compute node in the particular order, each of the messages resent with a second value of the generation number of the PTE, the second value different than the first value. The semantic response may comprise the second value of the generation number

Optionally, the destination compute node may perform additional steps. The destination compute node may perform a step of provisioning additional resources for the PTE in response to resource exhaustion of the PTE. The destination compute node may perform a step of incrementing the generation number of the PTE.

In an example implementation, a method, by a destination compute node, includes: provisioning additional resources for a processing table entry of a message processing table in response to resource exhaustion of the processing table entry; incrementing a generation number of the processing table entry from a previous value to a current value; rejecting a first message from a source compute node in response to the first message including the previous value of the generation number of the processing table entry; and accepting the first message from the source compute node in response to the first message including the current value of the generation number of the processing table entry. In some implementations of the method, the first message includes an index of the processing table entry, the index including the generation number. In some implementations of the method, where the first message includes a field for the index, and the field includes a subfield for the generation number. In some implementations of the method, the first message includes an index of the processing table entry, the index being different than the generation number. In some implementations of the method, the first message includes a first field for the index and a second field for the generation number. In some implementations, the method further includes: disabling the processing table entry before provisioning the additional resources for the processing table entry; and enabling the processing table entry after provisioning the additional resources for the processing table entry. In some implementations, the method further includes: rejecting a second message from the source compute node in response to the processing table entry being disabled; and accepting the second message from the source compute node in response to the processing table entry being enabled. In some implementations of the method, rejecting the second message from the source compute node includes: sending a semantic response to the source compute node, the semantic response lacking the current value of the generation number of the processing table entry. In some implementations of the method, rejecting the first message from the source compute node includes: sending a semantic response to the source compute node, the semantic response including the current value of the generation number of the processing table entry.

In an example implementation, a source compute node includes: a processor; and a non-transitory computer readable medium storing instructions which, when executed by the processor, cause the processor to: send a message to a destination compute node, the message including a first value of a generation number of a processing table entry at the destination compute node; receive a first semantic response from the destination compute node, the first semantic response indicating resource exhaustion of the processing table entry; wait a predetermined duration in response to receiving the first semantic response; and resend the message to the destination compute node after the wait of the predetermined duration, the message including a second value of the generation number of the processing table entry, the second value different than the first value. In some implementations of the source compute node, the instructions further cause the processor to: generate the second value of the generation number by incrementing the first value. In some implementations of the source compute node, the instructions further cause the processor to: receive a second semantic response from the destination compute node, the second semantic response indicating generational mismatch with the processing table entry; and resend the message to the destination compute node, the message including a third value of the generation number of the processing table entry, the third value different than the second value. In some implementations of the source compute node, the second semantic response includes the third value of the generation number. In some implementations of the source compute node, the message with the third value of the generation number is resent to the destination compute node without waiting after receiving the second semantic response. In some implementations of the source compute node, the message includes a field for addressing information of the message, and the field includes a subfield for the generation number. In some implementations of the source compute node, the message includes a first field for addressing information of the message and a second field for the generation number.

In an example implementation, a system includes: a destination compute node including a message processing table, the message processing table including a processing table entry, the processing table entry including a generation number; and a source compute node configured to: send a plurality of messages to the destination compute node in a particular order, each of the messages sent with a first value of the generation number of the processing table entry; receive a semantic response from the destination compute node, the semantic response indicating generational mismatch with the processing table entry; and resend the messages to the destination compute node in the particular order, each of the messages resent with a second value of the generation number of the processing table entry, the second value different than the first value. In some implementations of the system, the destination compute node is configured to: provision additional resources for the processing table entry in response to resource exhaustion of the processing table entry; and increment the generation number of the processing table entry. In some implementations of the system, the semantic response includes the second value of the generation number. In some implementations of the system, the processing table entry further includes an index and each of the messages is sent with the index.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A method, by a destination compute node, the method comprising:
provisioning additional resources for a processing table entry of a message processing table in response to resource exhaustion of the processing table entry;
incrementing a generation number of the processing table entry from a previous value to a current value;
rejecting a first message from a source compute node in response to the first message comprising the previous value of the generation number of the processing table entry; and
accepting the first message from the source compute node in response to the first message comprising the current value of the generation number of the processing table entry.

2. The method of claim 1, wherein the first message comprises an index of the processing table entry, the index comprising the generation number.

3. The method of claim 2, wherein the first message comprises a field for the index, and the field comprises a subfield for the generation number.

4. The method of claim 1, wherein the first message comprises an index of the processing table entry, the index being different than the generation number.

5. The method of claim 4, wherein the first message comprises a first field for the index and a second field for the generation number.

6. The method of claim 1, further comprising:
disabling the processing table entry before provisioning the additional resources for the processing table entry; and
enabling the processing table entry after provisioning the additional resources for the processing table entry.

7. The method of claim 6, further comprising:
rejecting a second message from the source compute node in response to the processing table entry being disabled; and
accepting the second message from the source compute node in response to the processing table entry being enabled.

8. The method of claim 7, wherein rejecting the second message from the source compute node comprises:
sending a semantic response to the source compute node, the semantic response lacking the current value of the generation number of the processing table entry.

9. The method of claim 1, wherein rejecting the first message from the source compute node comprises:
sending a semantic response to the source compute node, the semantic response comprising the current value of the generation number of the processing table entry.

10. A source compute node comprising:
a processor; and
a non-transitory computer readable medium storing instructions which, when executed by the processor, cause the processor to:
send a message to a destination compute node, the message comprising a first value of a generation number of a processing table entry at the destination compute node;
receive a first semantic response from the destination compute node, the first semantic response indicating resource exhaustion of the processing table entry;
wait a predetermined duration in response to receiving the first semantic response; and
resend the message to the destination compute node after the wait of the predetermined duration, the message comprising a second value of the generation number of the processing table entry, the second value different than the first value.

11. The source compute node of claim 10, wherein the instructions further cause the processor to:
generate the second value of the generation number by incrementing the first value.

12. The source compute node of claim 10, wherein the instructions further cause the processor to:
receive a second semantic response from the destination compute node, the second semantic response indicating generational mismatch with the processing table entry; and
resend the message to the destination compute node, the message comprising a third value of the generation number of the processing table entry, the third value different than the second value.

13. The source compute node of claim 12, wherein the second semantic response comprises the third value of the generation number.

14. The source compute node of claim 12, wherein the message with the third value of the generation number is resent to the destination compute node without waiting after receiving the second semantic response.

15. The source compute node of claim 10, wherein the message comprises a field for addressing information of the message, and the field comprises a subfield for the generation number.

16. The source compute node of claim 10, wherein the message comprises a first field for addressing information of the message and a second field for the generation number.

17. A system comprising:
a destination compute node comprising a message processing table, the message processing table comprising a processing table entry, the processing table entry comprising a generation number; and
a source compute node configured to:
send a plurality of messages to the destination compute node in a particular order, each of the messages sent with a first value of the generation number of the processing table entry;
receive a semantic response from the destination compute node, the semantic response indicating generational mismatch with the processing table entry; and
resend the messages to the destination compute node in the particular order, each of the messages resent with a second value of the generation number of the processing table entry, the second value different than the first value.

18. The system of claim 17, wherein the destination compute node is configured to:
provision additional resources for the processing table entry in response to resource exhaustion of the processing table entry; and
increment the generation number of the processing table entry.

19. The system of claim 17, wherein the semantic response comprises the second value of the generation number.

20. The system of claim 17, wherein the processing table entry further comprises an index and each of the messages is sent with the index.
